(19) United States
(12) Patent Application Publication
(10) Pub. No.: US 2005/0185921 A1
(43) Pub. Date: Aug. 25, 2005

(54) Systems and methods for enhanced video and audio program editing

(76) Inventors: Dale Skran, Marlboro, NJ (US); Raymond M. Candelora, Colts Neck, NJ (US); J. Gerard Aguilar, Oak Lawn, IL (US)

Correspondence Address: JONES DAY, 222 EAST 41ST ST, NEW YORK, NY, 10017, US

(21) Appl. No.: 11/064,228

(22) Filed: Feb. 22, 2005

Related U.S. Application Data
(60) Provisional application No. 60/546,251, filed on Feb. 20, 2004.

(51) Int. Cl. H04N 5/76; G11B 27/00

(52) U.S. Cl. 386/52; 386/68

(57) ABSTRACT

Systems and methods for editing a multimedia program are disclosed. A segment in a program is defined and then processed. The segment is defined by marking a beginning of the segment and the end of the segment. Imprecision in defining the segment is corrected. The defined segment may be deleted or programmed to repeat one or more times when the program is played in the future. A user defines the segment and processes it by supplying input signals to the system. The input signals may be generated by pressing buttons on a remote control.

This application claims priority of provisional application Ser. No. 60/546,251, filed on Feb. 20, 2004, which is incorporated herein by reference.

### FIELD OF INVENTION

The present invention relates to multimedia program editing, and more particularly to features of media players, such as video personal recorders (PVR), which provide users with enhanced functionality that can be used to quickly and effectively either remove segments from a live or pre-recorded program being played, or to add preferred program segment(s), possibly in repeat loops, for future playing. These features are enabled for use in both video/audio programs, or separately to video or audio programs running on a media player.

### BACKGROUND OF INVENTION

A wide variety of devices exist for recording audio and/or video from various sources and playing them back. These devices include but are not limited to: Video Cassette Recorders (VCR), which record on tape, Digital Video Disk (DVD) recorders, which record on DVDs, Personal Video Recorders (PVR)/Digital Video Recorders (DVR), which record on Hard Disk Drives (HDD), stereo systems, radios, Compact Disk (CD) players, etc. Such devices are typically controlled via remote controls, typically implemented as infrared (IR) controllers, although they could also be controlled by a variety of wired or wireless remote controls. Typically, these remote controls have a FAST FORWARD button that, when pressed, causes the program to move forward rapidly. In some cases, pressing the button multiple times provides a different functionality, such as causing the program to move forward at a different rate, for example more rapidly. These features are typical for video recorders, but are starting to appear in audio-only devices as well. As commercials are often interlaced with music, the same general need to skip commercials exists with both audio and video.

More recently, prior art devices have been provided with a SKIP control button that, when pressed, causes the program to move forward a given time interval (such as 30 seconds) for each button press. U.S. Patent Application No. A20020191950 discloses a system and method that enable or disable all manual and automated skipping functions of a video recording and playback device based on a content classification signal that is associated with a video signal. U.S. Patent Application No. A20020012526 discloses methods and systems that allow a user to easily and precisely shift (jump) the playing position to a scene of his choice and then start playing from the desired scene. U.S. Patent Application No. A20040018000 discloses a method and a system for accessing recorded video program, which can be displayed while the program is being recorded to a storage medium. U.S. Pat. No. 5,911,029 discloses setting a VCR to a cue mode when a commercial starts. Thereafter, a black frame detecting mechanism detects a black frame included in the reproduced signals between the commercial and a main program, whereby a microcomputer switches the VCR to standard playback mode at the time point of detection. The above prior art generally does not provide sufficient flexibility in editing certain segments in a program.

Different type of prior art references disclose providing automated content classification systems and methods for detecting and eliminating TV commercials. Prior art references pertinent to the field of television commercial detection and elimination systems, include for example U.S. Pat. No. 4,319,286 to Hanpachern, U.S. Pat. No. 4,750,052 to Poppy et. al., U.S. Pat. No. 4,752,834 to Koombes, U.S. Pat. No. 5,333,091 to Iggulden et. al., U.S. Pat. No. 5,692,093 to Iggulden et. al, and U.S. Pat. No. 5,986,866 also to Iggulden et. al, disclose automated television commercial detection based on some signals that are typical to commercials, such as blank or black video frames, blank video frames followed by “active scenes”, blank frames followed by another blank frame with a certain timing interval that is typical to commercials, or low audio signals with dark video frames. There is at least one automated solution commercially available for television commercial detection and elimination. The solution, called “Commercial Advance” (trademarked), is mainly based on the systems and methods disclosed in the following U.S. Pat. Nos. 5,333,091, 5,692,093, 5,986,866, all to Iggulden et al. Such automated commercial elimination methods do not allow a user to eliminate an unwanted portion of a program manually.

Another type of prior art references disclose the use of thumbnails. The term thumbnail generally means a reduced image of a graphic or document page. U.S. Pat. No. 6,154,771 discloses the use of thumbnails for video editing, but is focused on using them to manage a variety of video streams. U.S. Patent Application No. 20030206716 discloses using thumbnails as a general means of indexing video streams. This application also describes using a set of thumbnails to select the point at which rewinding or fast forwarding should stop. U.S. Patent Application No. 20030206716, is hereby incorporated by reference for all purposes. U.S. Patent Application No. 20030086691 discloses general means for setting video bookmarks through the use of thumbnails. These prior art references do not disclose using thumbnails for marking a segment of a program and processing such segment.

U.S. Pat. No. 6,477,312 discloses an external memory storage unit (referred to in the patent as “endless memory”). It discloses using a remote transmitter to mark a segment of the video signal for later replay. U.S. Pat. No. 6,236,312 is related to the insertion of skip, rewind, and play codes on a tape to alter the playback of the media stored on the tape. U.S. Pat. No. 5,258,875 discloses methods that require a number of tape drives to implement a replay function. U.S. Patent Application No. 20030194211 discloses a pre-established rather than dynamic selection of the amount of video being replayed. U.S. Application No. 20030108331 discloses a system that includes the functionality of a PVR in a television set. The above patents and patent applications are incorporated herein by reference for all purposes. The prior art does not disclose a PVR system capable of marking a segment of a program during the playback and then performing various the operations on the marked segment.

Some presently existing PVRs incorporate trick mode functions (functions for altering the speed and direction of viewing the program) enabling a user to fast forward and rewind a recorded multimedia program. These systems are not convenient for accessing a particular portion of the program, however, because a user often must scan through a substantial amount of recording until a particular portion of the program is found. This is time consuming, especially when the user wishes to skip from the end of a multimedia presentation back to the beginning, or from the beginning to the end.

Other existing PVRs provide an onscreen display that tracks the present time point in the program as trick mode functions are performed on the program. The onscreen display is typically limited to a cursor displayed within a track. The position of the cursor within the track changes to reflect the present time point within the program. However, the movement of the cursor is neither adequate to precisely determine the present time point within the program, nor to provide program information helpful in navigating through it.

Other PVRs allow a user to bookmark a multimedia program where a user had last stopped the program playback. Stopping the multimedia program whenever a user wishes to bookmark a particular segment can also be inconvenient and irritating to the user. Hence, bookmarking has a limited use for finding a specific segment of a multimedia program. Furthermore, bookmarks are typically erased after re-play of the multimedia program has commenced. Therefore, a user may only use the bookmark once to jump to a bookmarked portion of the program. After a single use, the user typically must revert to rewinding and fast forwarding through the multimedia program in order to review the particular segment again.

Accordingly, there is a need to develop a system and method for editing segments of multimedia programs that addresses deficiencies, examples of which were discussed above, associated with the prior art.

### SUMMARY OF INVENTION

This application relates to processing segments of a multimedia program (such as audio, video, or any type of multimedia program) being played, which enables users to conveniently extract, delete, and replicate such segments when played back. In a specific embodiment, processing is enabled through the use of a remote control mechanism, which may be provided with appropriate button functions. For example, in one embodiment a user may delete a segment of a program by pressing a button on the remote control in the beginning of the segment and in the end of the segment. Preferably, the user may adjust the boundaries of the segment i.e. its beginning or end or both, with additional button pressings.

In another embodiment, a user may identify the beginning of a segment by selecting a thumbnail from a set of thumbnails that is displayed as a result of the user requesting to display. In a specific embodiment this can be done by pressing a button on the remote control. In an exemplary embodiment the user may advance the program to the end of the segment and identify the end of the segment by selecting a thumbnail from a set of thumbnails that are displayed as a result of the user pressing a button on the remote control. In different embodiments, the user may also change the time window from which the set of thumbnails was sampled, and the sampling frequency in the set, as to identify the beginning and the end of a segment more precisely.

In another embodiment a user may select a number of repetitions of a program segment. In this embodiment, the user may identify the end of a segment by pressing a button, and then signify the number of times the segment should be repeated by repeatedly pressing the button. In a specific embodiment, the beginning of the segment is determined by subtracting a preconfigured number of seconds from the end of a segment. In another embodiment, the user may programs the number of repetitions by pressing a digit key on the remote control. In another embodiment, the user may alter the preconfigured time used in determining the length of the segment. In another embodiment, the user selects the beginning of the segment by rewinding the program and pressing the button used to identify the end of the segment. In another embodiment, the user may select the beginning and the end of a segment to be repeated by using thumbnails.

More specifically in one aspect this application is directed to a method for operating a media system comprising marking a first time point in a multimedia program playing on the media system, marking a second time point in the multimedia program, marking a third time point in the multimedia program, defining a segment in the program based on the marked first, second, and third time points, at least one of the beginning of the segment and the end of the segment being calculated using a mathematical formula using as parameter the first second and third marked points in the program, and processing the defined segment of the program.

In another aspect this application is directed to a method for operating a media system comprising displaying a first plurality of thumbnails corresponding to a select time in a program being played on the system, selecting one or more of the displayed first plurality of thumbnails, marking a beginning time of a program segment corresponding to a single thumbnail selected from the first plurality of thumbnails, displaying a second plurality of thumbnails corresponding to a second select time in the program, selecting one or more thumbnails of the displayed second plurality of thumbnails marking an end time of the program segment corresponding to a single thumbnail selected from the second plurality of thumbnails, processing the segment from the program.

In another aspect this application is directed to a method for operating a media system comprising marking an end time point of a segment in a program being played on the media system, entering a number of desired segment repetitions, calculating a beginning time of the segment, and processing the segment.

In another aspect this application is directed to a remote control for use in editing programs played on a multimedia system, comprising a control input generating signals that (a) mark one or more time points in a program being played on the system; and (b) indicate desired type of processing of program segments determined from said one or more time points in the program.

### BRIEF DESCRIPTION OF THE DRAWINGS

The present invention may be understood more fully by reference to the following detailed descriptions of the embodiments and the appended figures in which:

FIG. 1 illustrates a general PVR system in accordance with one embodiment;

FIG. 2 illustrates a distributed PVR system in accordance with one embodiment;

FIG. 3 illustrates a remote control in accordance with one embodiment;

FIG. 4 illustrates a method of removing an unwanted segment from a program in accordance with one embodiment;

FIG. 5 illustrates a method for removing an unwanted segment from a program using thumbnails in accordance with one embodiment;

FIG. 6 illustrates thumbnails of audio program with amplitude of the audio signal shown as a function of time in accordance with one embodiment;

FIG. 7 illustrates thumbnails of audio program with frequency of the audio signal shown as a function of time in accordance with one embodiment;

FIGS. 8-11 illustrate methods of programming a number of repetitions of a segment of a program in accordance with different specific embodiments.

### DETAILED DESCRIPTION OF THE PREFERRED EMBODIMENTS

The present application relates to methods for processing segments of a multimedia program. For purposes of illustration only, the following discussion is presented in the context of a Personal Video Recorder (PVR), sometimes referred to as Digital Video Recorder (DVR). It should however be understood that this is not intended as a limitation, and that various media players, such as TVs, Video Cassette Recorders (VCR), Personal Computer (PC), Media Players, etc. can also be used in alternative embodiments. In this application, a program refers to any media presentation, such as video, audio, video plus audio, a set of still images with associated audio, and offers types of programs that run in time and can be played on a media player.

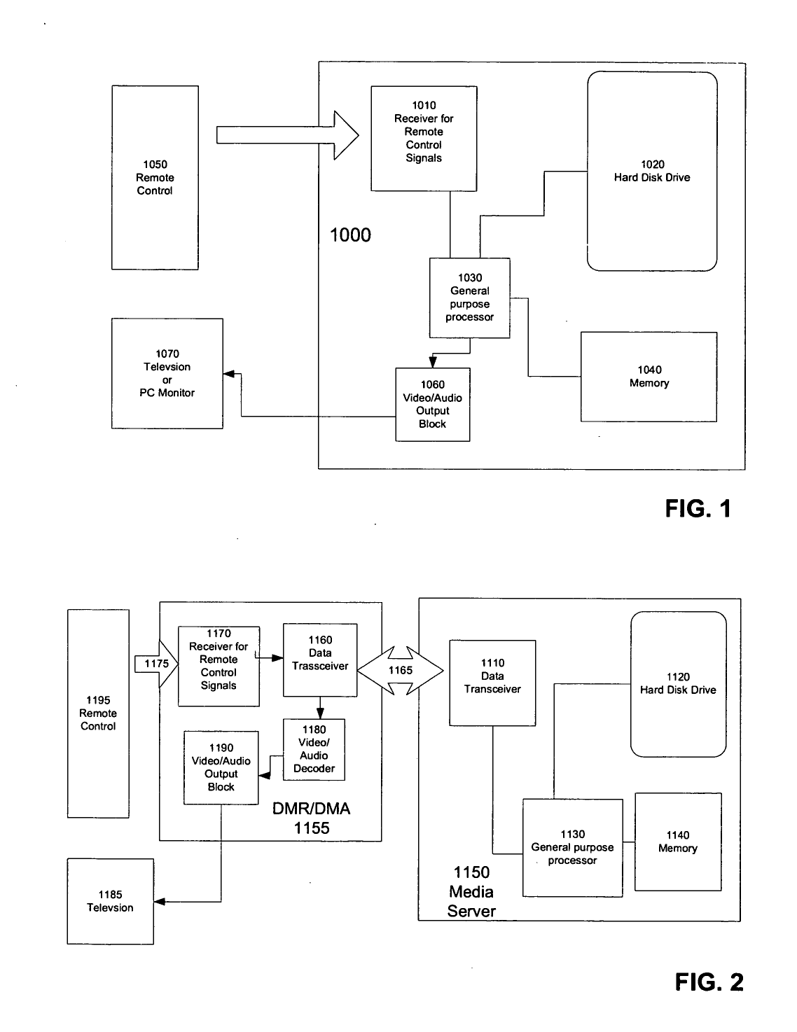

FIG. 1 illustrates one embodiment of the described system, showing a PVR 1000 as a stand alone device. The PVR 1000 comprises a general purpose processor 1030 and a memory 1040 for storing instructions capable of providing “time warping” and trick mode features. Time warping is a feature that allows a user to play back a program at a time other than the time that the programs was recorded. Time warping feature may be used to allow storing of one or more programs while simultaneously playing back one or more other programs. Trick mode features are features use for altering the direction and the speed of program playback, such as PAUSE, REWIND, and FAST FORWARD to a live broadcast or a pre-recorded television or radio program. Memory 1040 may be any sort of memory capable of storing instructions for execution in a general purpose processor 1030, such as for example, random access memory (RAM), read-only memory (ROM), etc.

In a preferred embodiment a multimedia program may be stored in memory 1020 in a number of ways. Memory 1020 is a device capable of random access, including reading and writing, to large amounts of program data, and is typically a HDD but may be other forms of memory including RAM, etc. The program may be received as a part of a live broadcast, copied from another media, such as CD, DVD, tape, etc., copied from another media system capable of playback, such as another PVR, VCR, CD player, tape player, DVD, computer, etc., downloaded from the Internet, etc. Memory 1040 is a general purpose memory, holding instructions executed on the general purpose processor 1030. Such memory may be a read only memory (ROM), flash memory, or any other type of memory capable of keeping information when the PVR 1000 is powered down. The PVR 1000 produces video and audio output that is transmitted to output systems by the video/audio output block 1060. The output block 1060 connects to an output device 1070 capable of reproducing both video and audio signals, such as a television set, or to separate devices such as a computer monitor and speakers. As shown, the PVR 1000 accepts inputs using the controls block 1010. In a preferred embodiment, an infrared (IR) remote control 1050 is used to supply input signals, as known in the art. However, input signals may be supplied in a number of different ways, such as by pressing buttons on the chassis of the PVR 1000, control over a computer network, and with the any controller connected to the PVR 1000 over a wire, such as game computer control, or wirelessly. The control need not necessarily be activated by pressing a button, it may be activated in different embodiments by voice commands or mouse clicks.

FIG. 2 illustrates a PVR implemented in another embodiment in distributed fashion. In this implementation, a Digital Media Render (DMR)/Digital Media Adaptor (DMA) 1155 connected to the storage of the program in a Media Server 1150 over a data network 1165, which may be wireless or may use a physical connection. The media server 1150 comprises a general purpose processor 1130, a memory 1120 for storing one or more programs, and a memory 1140 for storing instructions, similar to the corresponding elements illustrated in FIG. 1. Media Server 1150 comprises data transceiver 1110 that is connected to data transceiver 1160 of DMR/DMA 1155 over a communications network 1165. Data transceiver 1160 passes information received from Media Server 1150 to Video/Audio Decoder 1180 which applies codecs to the data received from the Media Server 1150. DMR/DMA 1155 has a video/audio output block connects to a video/audio equipment 1185 such as a television set, computer monitor, and speakers as discussed above in connection with element 1070. The Video/Audio Output Block transmits analog or digital information capable of being processed by the video/audio equipment 1185. DMR/DMA 1155 has an input block 1170 similar to the input block 1010 of the PVR 1000 in FIG. 1, which receives input signals from remote control 1195.

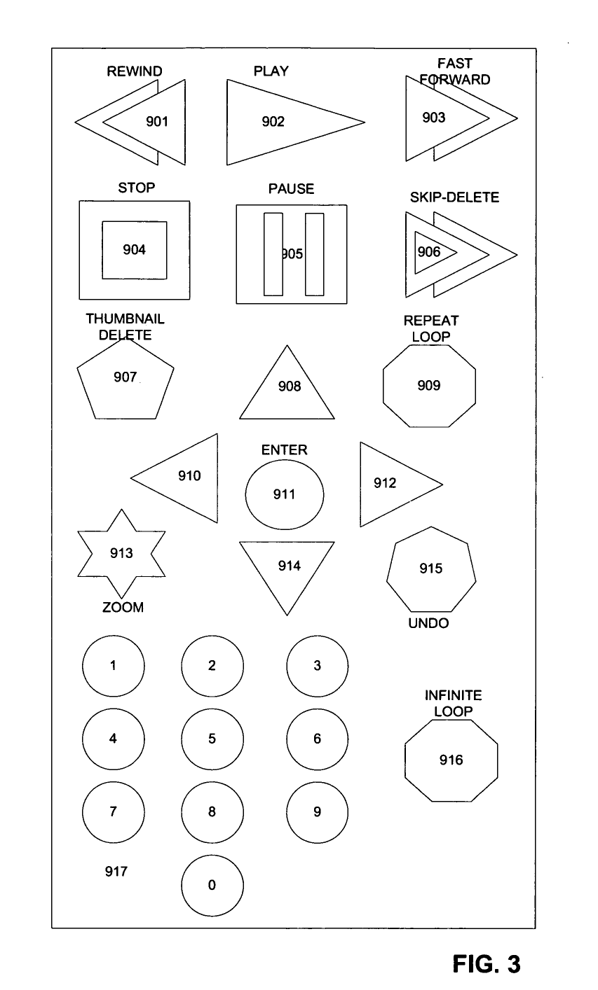

FIG. 3 illustrates a preferred embodiment of the remote control 1050 shown in FIGS. 1 and 1195 in FIG. 2. In the illustrated embodiment, remote control 1050 has a REWIND button 901, a PLAY button 902, a FAST FORWARD button 903, a STOP button 904, a PAUSE button 905, a SKIP DELETE button 906, a THUMBNAIL DELETE button 907, ARROW buttons 908, 910, 912, 914, an ENTER button 911, a ZOOM button 913, an UNDO button 915, the digit buttons (0-9) 917, and an INFINITE LOOP button 916. In alternative embodiments, the remote control may have different buttons in different configurations and layout. It will be understood that the names of the buttons recited above are for illustration only and do not affect their functionality. In alternative embodiments, the buttons used in the remote control may be “overloaded” in which case one button can configured to perform multiple functions in different contexts.

For the purposes of this application, “pressing” a button means depressing it and then releasing it, where releasing the button does not cause any action. “Pressing” in the following description is distinguished from “pressing and holding” in which case releasing the button that was held causes an action, and the amount of time that the button was held also may have functional significance.

In a different embodiments, when processing a segment of a program, the segment of the program is marked, and then some operation, such as deletion or storing multiple repetitions, is performed on this marked segment. These operations may be performed by actually removing or inserting multiple copies of the segment. Alternatively, pointers for skipping over the selected segments or for going back to the beginning of the segment may be used for the performance of these operations.

In different embodiments, feedback related to the status of operations may be provided if desired to the user via visual, auditory, or other means. In a preferred embodiment feedback is provided as on-screen messages.

In the first embodiment, the SKIP-DELETE button used in accordance with this disclosure is pressed and held down. In this embodiment, the beginning of a segment of the program is marked, and then the program begins to move forward rapidly. When the button is released, the end of the segment of the program is marked, and the rapid forward movement of the program stops. In a specific embodiment, the marked segment is then removed from the program. It has been observed that, when using fast forwarding, users overshoot, back up, and then go forward a small amount to continue with the program. This observation is taken into account in this embodiment by subsequent adjustment of the boundaries of the program segment.

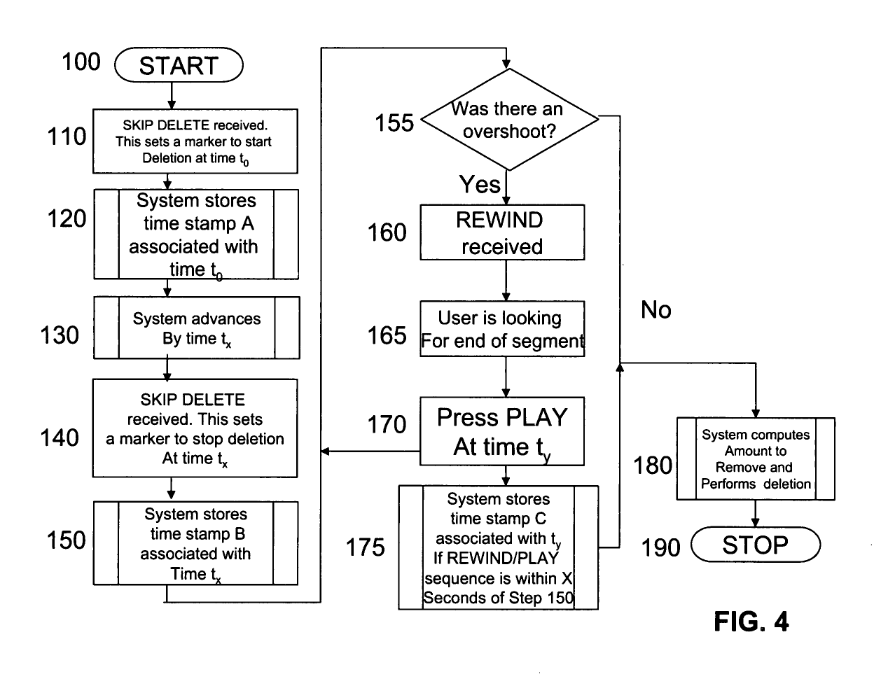

FIG. 4 illustrates a method of removing a segment from a program using the SKIP-DELETE button. In step 100 the program is played back normally. When the user observes the beginning of a segment that he wishes to edit the user presses the SKIP-DELETE button. In step 110, and with further reference to FIGS. 1 and 2, the signal caused by pressing and holding of the SKIP-DELETE button is received by the PVR. That causes the PVR to store a time stamp A associated with time Tₒ in step 120. The time stamp A may be some time offset (i.e. later) than the actual beginning of the segment that the user wishes to delete. In step 130, the PVR rapidly advances through the program while the SKIP-DELETE button remains depressed. In step 140, a signal that the SKIP-DELETE button has been released is received by the PVR. That causes the PVR to store time stamps B and C associated with time Tₓ in step 150, where Tₓ is greater or equal to Tₒ. In step 155, the user may consider whether there was a significant overshoot in the program play. If there was an overshoot that the user wishes to correct, the REWIND button is pressed by the user and the signal caused by pressing the REWIND button is received by the PVR in step 160. In step 165, the user searches for the end of the segment, while the program moves back rapidly. In an alternative embodiment, receiving the signal caused by pressing the REWIND button in step 160 causes the program to move back at a fraction of the usual rewind rate, for example ½. In step 170, the PVR receives the signal caused by pressing the PLAY button. That causes a change in time stamp C, which becomes associated with time T_{y} in the program in step 175. In step 180, the PVR applies mathematical formulas to the times of the three marked points and calculates the beginning and the end of the segment that the user wishes to edit for example by removing it from the program. To determine the beginning and the end times of the segment, in one embodiment, the PVR computes the lenth of the segment to be deleted by applying the formula:
Length=min(C,B)+Y−A+Z,
where Y is a configurable number of seconds of expected final overshoot and Z is a configurable number of seconds of expected initial overshoot. The default values for Y and Z are typically 5 seconds.

If in step 155 the user does not act within a preconfigured time period, then step 180, where the PVR determines the beginning and the end of the segment, is performed, bypassing steps 160-175.

In an alternative embodiment, marking of point A is accomplished by pressing the SKIP-DELETE button. Marking of point B (and initially C) is accomplished by pressing the PLAY button. In this embodiment, each additional press of the SKIP-DELETE button while the program is moving forward rapidly, causes the speed of the forward movement to increase by a preconfigured factor (such as x2).

In another alternative embodiment, only marking of point A is accomplished by pressing the SKIP-DELETE button, and the accelerated forward motion of the program is accomplished by pressing the FAST FORWARD button.

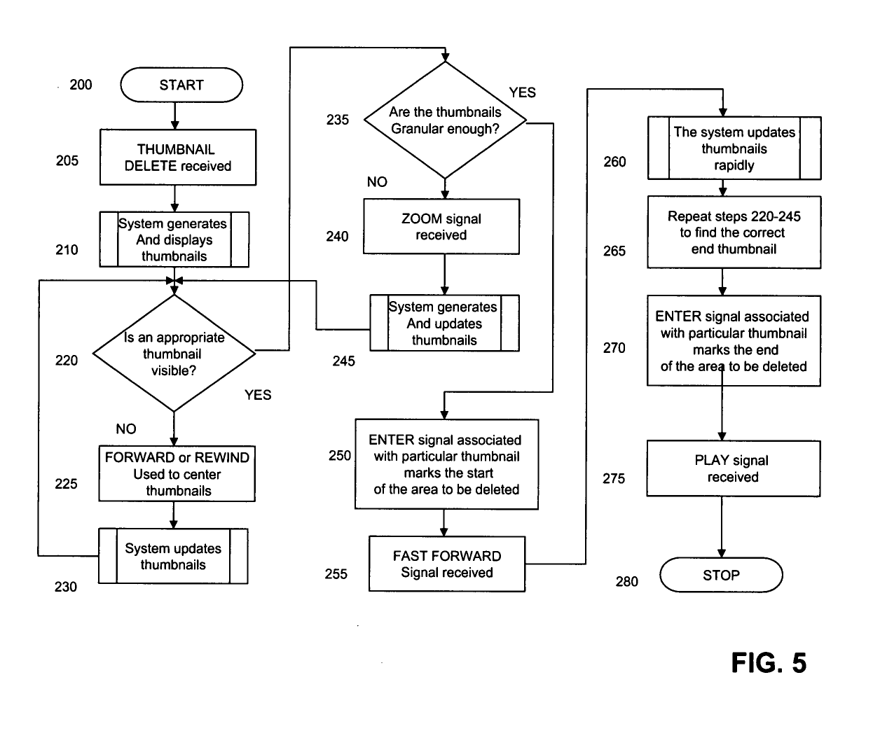

FIG. 5 illustrates an alternative method for removing a segment from a program using the THUMBNAIL DELETE button. In step 200, a user is watching (or listening) to a program. When the user observes the beginning of a segment that the user wishes to delete, the user presses the THUMBNAIL DELETE button. In step 205 the signal caused by pressing the THUMBNAIL DELETE button is received by the PVR. This results in a pause in the playback of the program at time Tₚ. In step 210, the PVR generates a set of still images (also called “thumbnails”). The images in the set correspond to times in the interval between Tₚ−T_{w} and Tₚ+T_{w} uniformly sampled at Tₛ, where T_{w} and Tₛ are configurable and are typically 60 and 5 seconds, respectively. If the media is video, the thumbnails are still images. Also, each thumbnail can have an activity marker. Before a video thumbnail is displayed, a motion activity detector software program can be used in a preferred embodiment to process the video. The results of the activity detection software program can be displayed as a solid color overlay within each thumbnail image, with the color indicating the presence or absence of motion. Motion activity detection programs are known in the art and will not be considered separately.

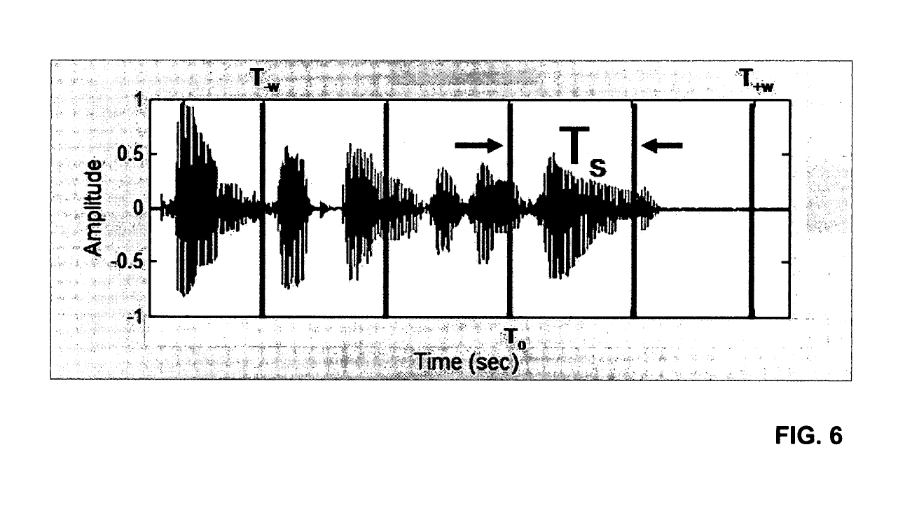

If the media is audio only, each thumbnail displays a portion of the continuous time domain audio waveform. When an audio thumbnail is selected by pressing one or more ARROW buttons, and then the PLAY button is pressed, a short audio segment corresponding to the thumbnail is played back. The waveform is appropriately anti-aliased to be displayable on a TV screen. FIG. 6 illustrates time-domain continuous waveform thumbnails.

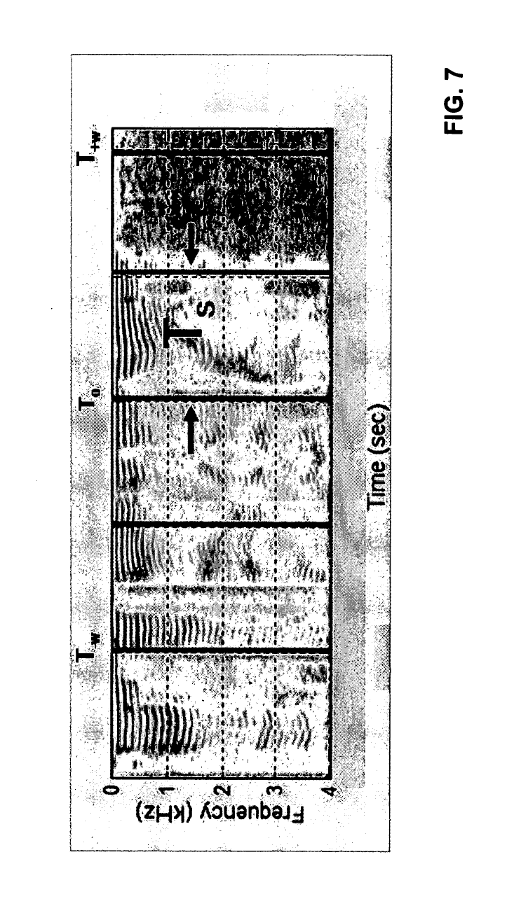

Alternatively, the audio can be displayed as continuous time-frequency spectrogram, where the audio energy in dB within each frequency band is shown as a function of time using various color levels. Preferably, each thumbnail contains an image of the audio spectrogram, where abscissa is time and ordinate is frequency. The spectrogram's parameters, such as sampling frequency, low pass filter, windowing function, window length, Discrete Fourier Transform length, window placement, sampling time, and color look up table are optimized to display audio information based on the audio source type (such as music or speech) and T_{w}. FIG. 7 illustrates a continuous spectrogram. In alternative embodiments, each audio thumbnail can have an activity marker overlain each of the thumbnails to indicate the presence of speech activity. This may be accomplished by processing a segment of audio to be displayed as thumbnails with a Voice Activity Detection (VAD) algorithm. Such VAD algorithms are known in the art and will not be considered separately. In some embodiments, the audio thumbnails may include visual attributes to facilitate differentiation between them. In alternative embodiments, the audio thumbnails contain a number of symbols that supports the requirement of visual differentiation between the audio thumbnails. Also, in this case the thumbnails are not contiguous initially, allowing a wider range of time to be covered. With reference to FIG. 3, when the signal caused by pressing of the ZOOM button is received, the thumbnails may become temporally contiguous. In this embodiment, navigating to a thumbnail and pressing the PLAY button to listen to the audio is expected to be the primary means by which the user decides where to mark the boundary of a program segment.

Referring back to FIG. 5, in step 220, the user decides whether a thumbnail corresponding to the beginning of the segment to be deleted is visible. If such thumbnail is not visible, the user presses the FAST FORWARD or the REWIND button to shift the displayed thumbnails forward or backward, respectively. The PVR receives the signal caused by pressing one of those buttons in step 225. The PVR displays another set of thumbnails in step 230 and the user decides whether the thumbnail corresponding to the beginning of the segment is visible in step 220. This sequence of steps 220-230 repeats until the user determines that the appropriate starting thumbnail of the segment is visible at which point the method proceeds to step 235.

In step 235, the user determines whether the resolution achieved by the sampling frequency 1/Tₛ is sufficient, in other words, whether the sampling interval Tₛ is short enough to be able to precisely identify the beginning of the segment. If the user determines that the resolution is not sufficient, the user may press a ZOOM button used in a preferred embodiment and illustrated in FIG. 3. The signal caused by pressing the ZOOM button is received by the PVR in step 240, which results in shortening Tₛ by a preconfigured factor F, where F is greater than 1 (such as a factor of 2). The PVR displays the re-sampled set of images in the interval between Tₚ−T_{w}/F and Tₚ+T_{w}/F in step 245. This may result in some images that were displayed before pressing the ZOOM button no longer being displayed. The user has an option of making the determination of whether the thumbnail corresponding to the beginning of the segment is visible in step 220 after step 245. Steps 220-245 are performed until the PVR displays a set of thumbnails sampled with a satisfactory resolution, and containing the thumbnail corresponding to the beginning of the segment to be edited.

In step 250, the PVR receives the signal caused by the user selecting a thumbnail from the ones displayed by the PVR by navigating to it with the ARROW buttons on the remote control device and pressing the ENTER button once the desired thumbnail is highlighted. In step 255 the PVR receives the signal caused by pressing a button (such as FAST FORWARD) on the remote control. It causes a rapid update of the thumbnails on the screen in step 260. In step 265 the user stops the rapid update by pressing another button (such as THUMBNAIL DELETE) on the remote control. At this point the users sees a set of thumbnails displayed by the PVR. The user follows the steps identical to steps 220-250 to select a thumbnail corresponding to the end of the segment to be deleted. In step 275, the user presses the PLAY button on the remote control. In one embodiment, the playback resumes at the point in the program when the THUMBNAIL DELETE button was pressed for the first time in step 205. In another embodiment, the playback resumes before the deleted segment, so the quality of the editing may be immediately verified. The choice between these two options may be configurable.

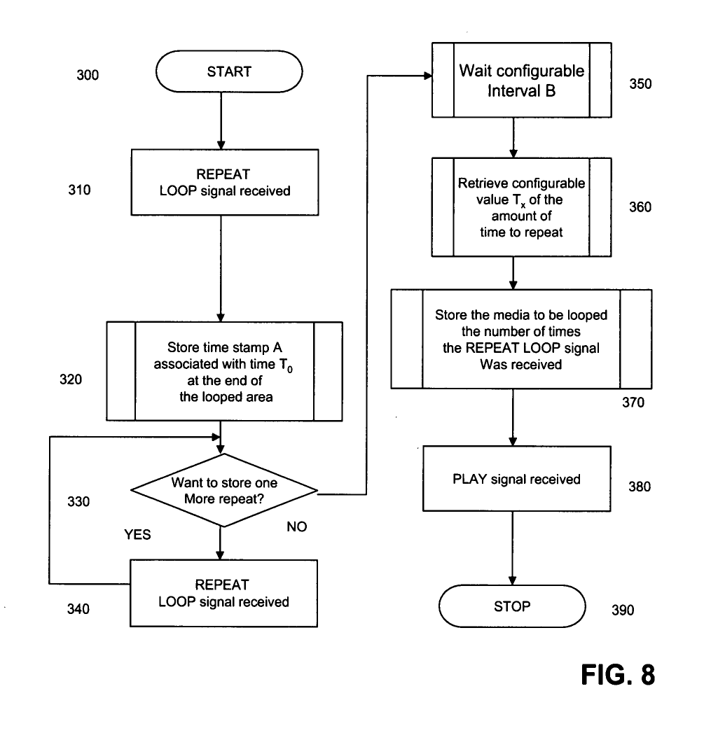

FIG. 8 illustrates a method of programming a number of repetitions of a segment to be stored on the mass storage media as a part of the program for future viewing. In step 300, a user is watching a program and identifies the beginning of the segment that the user wishes to repeat. The user takes no action and lets the program run normally until he identifies the end of the segment. In step 310, the signal caused by pressing the REPEAT LOOP is received by the PVR. That causes marking of the point A associated with time Tₒ at the end of the segment to be repeated in step 320. In step 330 the user may decide whether to store one more repetition of the segment. If additional repetition is desired, the user presses the REPEAT LOOP button, and the signal caused by pressing the REPEAT LOOP button is received by the PVR in step 340. After the user has pressed the REPEAT LOOP button the desired number of times and determines that the desirable number of repetitions has been programmed, he takes no action for a preconfigured time interval in step 350. After the PVR receives no signals within time interval B, it retrieves a pre-configured value Tₓ corresponding to the duration of the loop and calculates the beginning time of the loop in step 360. In step 370 the PVR stores the selected segment to its mass storage as many times as was specified by the user in steps 330-340. In step 380 the PVR receives the signal caused by pressing the PLAY button and the playback is restored at the point where the REPEAT LOOP was first pressed.

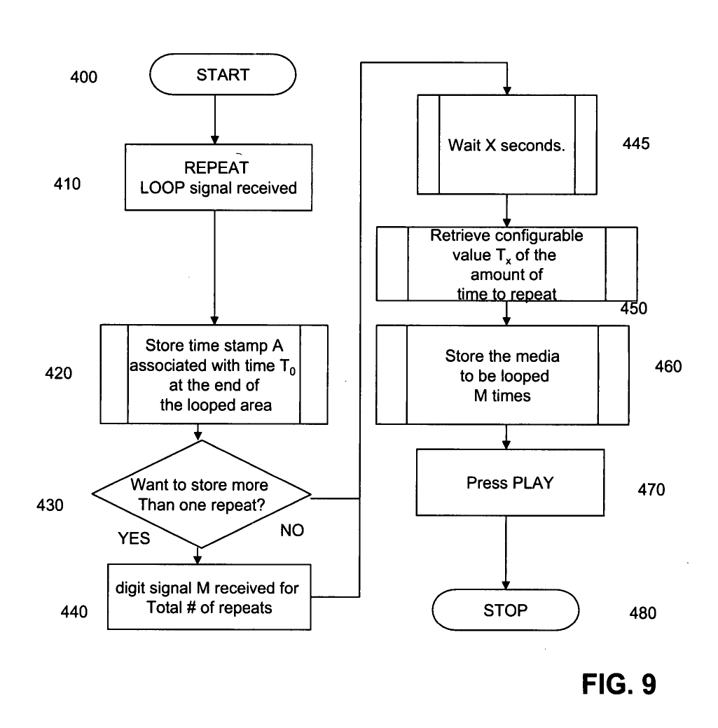

FIG. 9 illustrates a modification of the method illustrated in FIG. 8. In step 400 a user is watching a program and identifies the beginning of the segment that he wishes to repeat. The user takes no action and lets the program run normally until he identifies the end of the segment. In step 410, the signal caused by pressing the REPEAT LOOP button is received by the PVR. That causes marking of the point A associated with time Tₒ at the end of the segment to be repeated in step 420. In step 430 the user decides if he desires to store more than one repetition of the segment. If additional repetitions are desired, the user presses one of the digit buttons (button M), and the signal by pressing the button is received by the PVR in step 440. After the PVR receives no signals within X seconds, it retrieves a pre-configured value Tₓ corresponding to the duration of the loop and calculates the beginning time of the loop in step 450. In step 460 the PVR stores the selected segment to its mass storage M times, as was specified by the user in steps 430-440. In step 470 the PVR receives the signal caused by pressing the PLAY button and the playback is resumed at the point where the REPEAT LOOP was first pressed.

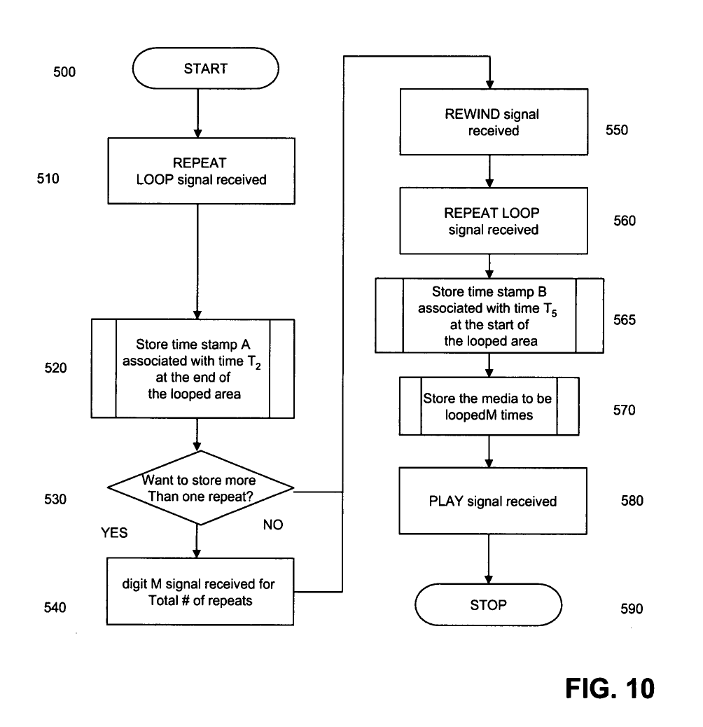

FIG. 10 illustrates a modification of the method illustrated in FIG. 9. In step 500 a user is watching a program and identifies the beginning of the segment that he wishes to repeat. The user takes no action and lets the program run normally until he identifies the end of the segment. In step 510, the signal caused by pressing the REPEAT LOOP is received by the PVR. That causes marking of the point A associated with time T₂ at the end of the segment to be repeated in step 520. In step 530, the user decides if he desires to store more than one repetition of the segment. If additional repetitions are desired, the user presses one of the digit buttons (button M), and the signal caused by pressing the button is received by the PVR in step 540. In step 550 the PVR receives the signal caused by pressing the REWIND button. This results in the program moving backward rapidly. When the user reaches the beginning of the segment to be repeated, the user presses the REPEAT LOOP button. In step 560, the PVR receives the signal caused by pressing the REPEAT LOOP button. In step 565, the PVR marks time stamp B associated with time T₅ at the beginning of the segment. In step 570 the PVR stores the selected segment to its mass storage M times as was specified by the user in steps 530-540. In step 580 the PVR receives the signal caused by pressing the PLAY button and the playback is restored at the point where the REPEAT LOOP was first pressed.

In an alternative embodiment, the beginning and the end of the segment can be marked by using thumbnails and the THUMBNAIL DELETE button.

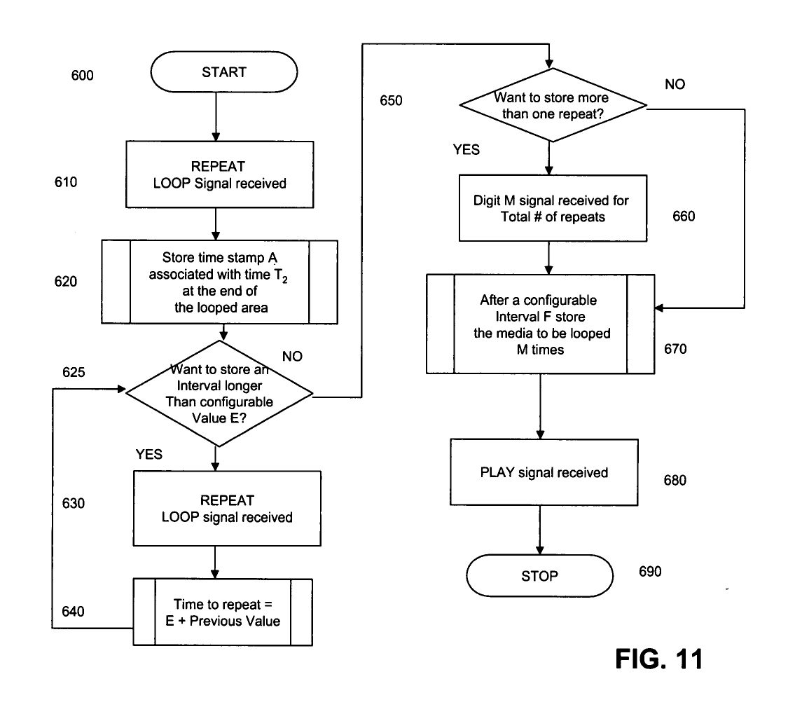

FIG. 11 illustrates another modification of the method of programming a number of repetitions of a segment to be stored on the mass storage media as a part of the digital media for future viewing. In step 600, a user is watching a program and identifies the beginning of the segment that he wishes to repeat. The user takes no action and lets the program run normally until he identifies the end of the segment and presses the REPEAT LOOP button. In step 610 the PVR receives the signal caused by pressing the REPEAT LOOP button. That causes marking of time stamp A associated with time T₂ and the end of the segment to be repeated in step 620. In step 625 the user makes a decision whether the desired duration of the repeated segment should be greater than the preconfigured value, which is typically 30 seconds. If the user decides that the duration should be greater, then he presses the REPEAT LOOP button. In step 630, the PVR receives the caused by pressing the REPEAT LOOP button. In step 640, the duration of the segment increases by the preconfigured value E. The sequence of steps 625-640 will repeat until the user is satisfied with the duration. After the user determines that the duration is appropriate, the user decides whether he wants to store more than one repetition of the segment in step 650. If an additional repetitions are desired, the user presses one of the digit buttons (button M), and the signal caused by pressing the button is received by the PVR in step 660. If only one repetition of the segment is desired then step 660 is bypassed. In step 670 the PVR stores the segment to be repeated the specified number of M times. In step 680, the PVR receives the signal caused by pressing the PLAY button and the program playback resumes at the point when the REPEAT LOOP button was pressed. If the user wishes to view the repeated segment, he rewinds the program to the point in the program preceding the repeated segment.

In some embodiments, the user may press the INFINITE LOOP button 916 in FIG. 3 before pressing the PLAY button, causing the looped segment to be repeated until the PLAY button is pressed. Alternatively the infinite loop operation may be used as a default. The selected segment would play in an infinite loop until the PLAY button is pressed.

Another alternative for all modifications of the method for programming the repeated playback of a segment is that pressing the PLAY to resume the playback causes the playback to be resumed in the beginning of the repeated segment.

Those of skill in the art will appreciate that the above description of the preferred embodiments is for illustration purposes only, and is not limiting on the scope of the invention, which is defined in the following claims.

1. A method for operating a media system comprising:
marking a first time point in a multimedia program playing on the media system;
marking a second time point in the multimedia program;
marking a third time point in the multimedia program;
defining a segment in the program based on the marked first, second, and third time points, at least one of the beginning of the segment and the end of the segment being calculated using a mathematical formula using as parameter the first second and third marked points in the program; and
processing the defined segment of the program.

2. The method of claim 1 wherein processing the segment comprises deleting the segment from a storage media.

3. The method of claim 1 wherein processing the segment comprises repeating the segment one or more times.

4. The method of claim 1 wherein processing the segment comprises playing the segment in a warped time.

5. A method for operating a media system comprising:
displaying a first plurality of thumbnails corresponding to a select time in a program being played on the system;
selecting one or more of the displayed first plurality of thumbnails, marking a beginning time of a program segment corresponding to a single thumbnail selected from the first plurality of thumbnails;
displaying a second plurality of thumbnails corresponding to a second select time in the program;
selecting one or more thumbnails of the displayed second plurality of thumbnails marking an end time of the program segment corresponding to a single thumbnail selected from the second plurality of thumbnails; and
processing the segment from the program.

6. The method of claim 5 wherein processing the segment comprises deleting the segment from a storage media.

7. The method of claim 5 wherein processing the segment comprises repeating the segment one or more times.

8. The method of claim 5 wherein processing the segment comprises playing the segment in a warped time.

9. A method for operating a media system comprising:
marking an end time point of a segment in a program being played on the media system;
entering a number of desired segment repetitions;
calculating a beginning time of the segment; and
processing the segment.

10. The method of claim 9 wherein entering a number of desired segment repetitions comprises pressing a button one or more times.

11. The method of claim 9 wherein calculating the beginning time of the segment comprises using a mathematical formula using as a parameter the end time of the segment.

12. The method of claim 9 wherein processing the segment comprises repeating the segment one or more times.

13. A remote control for use in editing programs played on a multimedia system, comprising:
a control input generating signals that:
(a) mark one or more time points in a program being played on the system; and
(b) indicate desired type of processing of program segments determined from said one or more time points in the program.

14. The remote control of claim 13, wherein the control input signals generated are infrared control signals.

15. The remote control of claim 13, wherein the control input generating time point marks comprises a button operable to generate signals by one or more of
(i) depressing the button;
(ii) releasing the button; and
(iii) calculating the time the button has been depressed.

16. The remote control of claim 13, wherein the control input generating signals indicating desired processing type comprises a button operable to generate signals for one or more of:
(i) segment deletion;
(ii) segment repetition;
(iii) segment playback at warped time.
